(19) United States
(12) Patent Application Publication
(10) Pub. No.: US 2012/0135107 A1
(43) Pub. Date: May 31, 2012

(54) METHOD FOR PREPARING A LEAVENED, MECHANICALLY DEVELOPED BREAD DOUGH

(75) Inventors: Roberto Bertolazzi, Durban (ZA); Terence Michael Sharp, Cheltenham (GB); Samuel John Millar, Evesham (GB)

(73) Assignee: CAMPDEN TECHNOLOGY LIMITED, Glouvestershire (GB)

(21) Appl. No.: 13/321,278

(22) PCT Filed: May 10, 2010
(86) PCT No.: PCT/EP2010/056373

§ 371 Date: Jan. 18, 2012

Related U.S. Application Data
(62) Division of application No. 61/179,920, filed on May 20, 2009.

(30) Foreign Application Priority Data
May 20, 2009 (EP) 09160793.7

(51) Int. Cl. A21D 8/02; B29B 11/14; A21C 9/08; A21C 13/00; A21D 13/00; A21C 1/08

(52) U.S. Cl. 426/8; 426/19; 426/27; 426/559; 426/665; 425/144

(57) ABSTRACT

The present invention relates to a method of preparing a leavened bread dough, said method comprising the following sequence of processing steps:
combining flour, water, yeast and/or leavening agent, and optionally one or more additional bakery ingredients to produce a dough-type mix;
mixing and working the dough-type mix in a mixer to produce an underdeveloped dough with a density of 0.9-1.5 g/ml, the total energy input from the mixer into the underdeveloped dough during said mixing and working of the dough-type mix being at least 1 W.h/kg;
further working a batch of at least 15 kg of the underdeveloped dough by subjecting it to deformation shear, thereby producing a developed dough;
dividing the developed dough into two or more developed dough pieces having an individual mass of 30-3000 g; and
leavening the developed dough pieces to yield leavened dough pieces having a specific volume of at least 2.0 ml/g;
wherein the aforementioned sequence of processing steps is completed within 3 hours.

The present process employs high energy working to produce an underdeveloped dough, followed by low energy working to further develop the dough. By employing a combination of high energy working and low energy working the total working energy needed for preparation of a fully developed dough can be reduced substantially. At the same time, this combination of working conditions produces a dough that after baking yields a very soft crumb with an extremely regular crumb structure.

The invention further provides a loaf of tin bread having a unique cellular structure that can be obtained by the aforementioned method as well as an apparatus for operating the above mentioned method.

### TECHNICAL FIELD OF THE INVENTION

The present invention relates to a method for preparing leavened mechanically developed bread dough, more particularly a method that produces such a leavened dough within 3 hours.

The invention further provides a loaf of tin bread having a unique cellular structure that can be produced by the aforementioned method. The invention also provides an apparatus that can suitably be used for producing a leavened bread dough by means of the aforementioned method.

### BACKGROUND OF THE INVENTION

For many years attention in the bakery industry has been directed to the production of a so-called “no-time” dough, which may be generally defined as a dough which is not derived using a sponge, and which does not require any or any substantial fermentation in bulk. The achievement of a satisfactory “no time” dough production method is desirable, because bulk fermentation is one of the most time consuming steps in the bread making process.

In 1937 Baker and Mize showed in a paper entitled “Mixing doughs in vacuum and in the presence of various gases” (published in “Cereal Chemistry, vol. 14” page 721) that the texture of bread was largely influenced by the gas cells present in the dough. In another paper, the same authors showed that the gas cells were all present after dough mixing and that a “no-time” dough could be made using oxidising agents. (“The origin of the gas cell in bread dough” Baker and Mize, published in “Cereal Chemistry, vol. 18, January 1941” at pages 19 to 33).

In England, in 1961, the Flour Milling and Baking Research Association at Chorleywood achieved successful production of no-time dough and it was shown that the process was essentially controlled by the energy input to the dough during mixing and that this energy must be added within five minutes. This is referred to hereinafter as “the Chorleywood Bread Process” or “CBP”.

The CBP employs mechanical dough development, a technique that brings about desirable changes in the physical properties of the dough that are normally brought about over extended time periods by fermentation. These desirable changes are achieved by a short period of intense mechanical development, usually in the presence of a small amount of added fat and a moderately high level of a synthetic oxidising agent. In mechanical dough development, the initial fermentation step is replaced by a short period of intense mixing in a special high-powered batch mixer that imparts between 5 and 12 W.h/kg (Watt-hours per kilogram) of work to all the dough ingredients in two to five minutes. In the high-powered batch mixer flour, chemical oxidants and other “improvers” together with water, yeast, fat and salt are mechanically mixed until a gluten-developed dough is formed. The large amount of energy used generates high temperatures in the dough. The air pressure in the mixer headspace is usually maintained at a partial vacuum in the latter stages of mixing to control gas bubble numbers and size in the dough.

The dough is cut into individual pieces and allowed to relax for up to 8 minutes. Each piece of dough is then shaped further, often such that 4 pieces are produced. The dough is placed in a tin which is moved to the humidity and temperature controlled proofing chamber, where it sits for about an hour. Baking takes approximately 20 to 30 minutes at approx. 240° C. and then the loaves go to the cooler, where, about two hours later they are sliced, packaged and ready for dispatch.

The CBP is now used to make the bulk of the UK's bread. The process has had an important impact in the UK, as at the time, few domestic wheat varieties were of sufficient quality to make high quality bread products using a bulk fermentation process, and it therefore permitted a much greater proportion of low-protein domestic wheat to be used in the grist. The CBP has been used in at least 28 countries worldwide, and has made inroads in France, Germany and Spain, with plans to introduce the system to China.

Despite the fact that mechanical dough development is widely used in the industrial production of, e.g. bread, there are still some drawbacks associated with this particular dough processing technique. One such drawback is the very high energy input that is needed to mechanically develop the dough. Another shortcoming of mechanical dough development resides in the irregular and/or coarse crumb structure that is sometimes observed in bread products produced with this technique, often caused subsequently by a lack of careful handling in the dough moulding stage of the process.

A further problem occurs when the CBP is used in high ambient temperature environments, since the energy imparted to the dough during the intensive mixing process raises the dough temperature to the point where the dough can become too soft and sticky to handle.

### SUMMARY OF THE INVENTION

The inventors have designed a new process for the production of a leavened, mechanically developed dough that does not suffer from the aforementioned drawbacks. The inventors have unexpectedly discovered that it is possible to realize the full benefits of mechanical dough development with a much lower energy input by working the dough in a two-step process comprising a first high energy working step followed by a second low energy working step. The first working step, i.e. the high energy working step, comprises the preparation of underdeveloped dough using a dough mixer with an energy input of at least 1 W.h/kg. This high energy working step is followed by a second low energy working step in which the underdeveloped dough is transformed into a developed dough by subjecting it to deformation shear (e.g. lamination), followed by dividing of the developed dough into developed dough pieces and leavening of these dough pieces.

The terms “high energy”, “low energy” and “critical energy level” as used herein refer to the rate of energy imparted to the dough. When dough is deformed by a working element, it undergoes a deformation, which is both plastic and elastic, and, due to its elastic properties, the dough recovers its shape (this is called relaxation) to a certain extent. The initial relaxation is fairly rapid but complete relaxation would take a long time, the time also depending on the impact of the working element on the dough. If a recurrent beating action is taking place, as in all mechanical dough kneaders, low energy is the rate of energy input into the dough at which substantial relaxation occurs between successive strokes, high energy is the rate at which no substantial relaxation occurs, and the critical energy level is the rate at which high energy becomes low energy, or vice versa, it being understood that this level can only be defined approximately and that this level varies from dough to dough.

It is believed that if dough is only worked below the critical level (low energy working), as in traditional commercial methods of preparing bread dough, it does not achieve optimum development through the action of mixing alone. In mechanical dough development, such as the CBP, primary and secondary development are achieved by a short period of high energy working in a mixer with rotating blades providing a vigorous mechanical action, thereby breaking up the intermolecular cross-connections and incorporating free molecules of oxygen, nitrogen and other minor gases from the air.

The present process employs high energy working to produce an underdeveloped dough, followed by low energy working to further develop the dough. By employing a combination of high energy working and low energy working the total working energy needed for (fast) preparation of a fully developed dough can be reduced substantially. At the same time, this combination of working conditions produces a dough that after baking yields a very soft crumb with an extremely regular crumb structure.

Thus, one aspect of the present invention relates to a method of preparing a leavened bread dough, said method comprising the following sequence of processing steps:

combining flour, water, yeast and/or leavening agent, and optionally one or more additional bakery ingredients (e.g. oxidizing agent) to produce a dough type mix;

mixing and working the dough-type mix in a mixer to produce an underdeveloped dough by employing a total energy input from the mixer of at least 1 W.h/kg;

further working a batch of at least 15 kg of the underdeveloped dough by subjecting it to deformation shear;

dividing the developed dough into developed dough pieces; and

leavening the developed dough pieces.

The inventors have discovered that the aforementioned method can be used in the production of a loaf of tin bread that has advantageous properties due to a unique cellular structure. The method according to the present invention typically yields a developed dough in which most gas cells are disk-shaped (oblate) ellipsoids. Advantageously, pieces of this developed dough are placed together in a tin, each piece being oriented in such a way that the polar axis of the ellipsoid gas cells coincides with the length dimension of the tin. During the subsequent leavening in the tins, the ellipsoid cells change from oblate ellipsoids into scalene ellipsoids as the gas cells become elongated in a vertical direction during the leavening.

The bread loaf obtained by baking this dough exhibits a unique cellular structure that is easily recognized when comparing three perpendicular cross sections of the loaf. This unique cellular structure was found to substantially increase the bread crumb's resistance against tear during spreading. Furthermore, slices of the loaves exhibiting this unique cellular structure have a very bright appearance which is highly appreciated in white bread. Finally, these loaves have a very regular shape, which makes them perfectly suitable for the industrial production of sandwiches.

Thus, another aspect of the invention relates to a loaf of tin bread having a specific volume of at least 3.5 ml/g wherein most of the cells contained in the loaf have the shape of scalene ellipsoids; the polar radius of said ellipsoids coinciding with the length dimension of the loaf, the minor equatorial radius coinciding with the width dimension of the loaf and the major equatorial radius coinciding with the height dimension of the loaf.

Yet another aspect of the invention relates to an apparatus that can suitably be used to perform the aforementioned method, said apparatus comprising the following equipment:

a high speed dough mixer for mixing dough ingredients and working the resulting dough;

a first conveying means for transporting dough away from the high speed mixer;

a dough working means for low energy working of dough by means of deformation shear, being positioned downstream of the first conveying means and comprising one or more rollers for squeezing a dough layer;

a second conveying means for transporting dough away from the dough working means;

a cutting device for dividing dough into two or more dough pieces, being positioned downstream of the second conveying means;

a third conveying means for transporting dough away from the cutting device;

a proofing device for raising, dough positioned downstream of the third conveying means.

### FIGURES

FIG. 1 is a C-Cell™ Image of a slice of white tin bread made by the Chorleywood Bread Process

FIG. 2 is a C-Cell™ Image of a slice of white tin bread made by the present method

FIG. 3 is a C-Cell™ Image of a vertical longitudinal cross-section of a loaf of white tin bread made by the present method (5 W.h/kg), showing the calculated elongation vectors (white lines).

FIG. 4 is a C-Cell™ Image of a vertical longitudinal cross-section of a loaf of white tin bread made by the present method (11 W.h/kg), showing the calculated elongation vectors (white lines)

FIG. 5 is a C-Cell™ Image of a vertical longitudinal cross-section of a loaf of white tin bread made by the Chorleywood Bread Process, showing the calculated elongation vectors (white lines)

### DETAILED DESCRIPTION OF THE INVENTION

Accordingly, one aspect of the invention relates to a method of preparing a yeast or chemically leavened bread dough, said method comprising the following sequence of processing steps:

combining flour, water, yeast and/or leavening agent, and optionally one or more additional bakery ingredients to produce a dough-type mix;

mixing and working the dough-type mix in a mixer to produce an underdeveloped dough with a density of 0.9-1.5 g/ml, the total energy input from the mixer into the underdeveloped dough during said mixing and working of the dough-type mix being at least 1 W.h/kg;

further working a batch of at least 15 kg of the underdeveloped dough by subjecting it to deformation shear, thereby producing a developed dough;

dividing the developed dough into two or more developed dough pieces having an individual mass of 30-3000 g; and

leavening the developed dough pieces to yield leavened dough pieces having a specific volume of at least 2.0 ml/g;

wherein the aforementioned sequence of processing steps is completed within 3 hours.

In mixing and working dough, four different effects occur, though these do not occur in precisely defined stages; the effects are mixing, hydration, primary development and secondary development.

Mixing is the mere mechanical blending of the ingredients to distribute the particles or molecules uniformly. In hydration, the water in the mix is absorbed by the damaged starch granules of the flour as all suitable flours have a deliberate proportion of damaged starch granules so that they can absorb water in this manner; the undamaged starch granules do absorb some water, but very much more slowly. During mixing, the protein in the flour also absorbs water, and this is the first step in developing the gluten structure in the dough.

The primary development of dough is the opening out of the protein structure (also called gluten fibrils) in the flour. The gluten structures are initially of a closely-packed, tightly coiled form, and can be opened out into fairly short helices with cross-connections.

The secondary development of dough is the breaking and re-attachment of the cross-connections. The cross-connections are fairly easily broken and the broken ends can re-attach in any chance combination. During the breaking and reattachment, free atoms such as oxygen or nitrogen atoms are included in the structure, producing a dough mass of long molecules which can stretch and enclose bubbles of gas. The re-arrangement of the cross-connections is catalysed by enzymes, which occur naturally in flour.

The development of a dough (primary and secondary together) can be measured by its elasticity, the dough becoming more elastic as it develops further, and an operator can gauge the amount of development by the feel of the dough. However, dough can be over-developed, when it loses the elasticity needed to allow it to be expanded properly by the gases during baking, and thus there is a peak development or optimum development, which in general terms can be gauged as that development at which the maximum increase in volume occurs on baking.

In the present method, the underdeveloped dough obtained after the mixing and high energy working of the dough-type mix is characterized in that it contains very small gas cells that will grow substantially in volume during the leavening of the dough. The rheological properties of the underdeveloped dough differ from those of a fully developed dough in having a reduced capacity to expand and retain gas. In the second low energy working step that employs a combination of compression and shear to work the underdeveloped dough, a fully developed dough can be obtained that exhibits optimum elasticity and machineability.

The term “deformation” as used herein refers to mass deformation by a squeezing or wedging action which occurs when dough is subjected to e.g. compression or stretching. Within the context of the present invention deformation of the underdeveloped dough produces “deformation shear” when the deformation is sufficiently large and occurring at a sufficiently high rate to produce slip between a large number of individual gluten structures as these may slide over one another, in particular creating long-chain glutens for re-forming them into a more cell-like structure. In contrast, the mixer that is employed in the present method to produce the underdeveloped dough, is used to cut and/or shred the dough with e.g. a high velocity blade, giving a high rate of absorption of water which will eventually lead to a re-structuring of the wheat proteins into gluten.

In order to achieve full development of the dough within a short time frame it is advantageous to employ an oxidizing agent in the dough-type mix. Advantageously, the dough-type mix contains an oxidizing agent selected from:

10-300 mg, preferably 25-250 mg ascorbic acid equivalents per kg of flour;

5-100 mg, preferably 15-50 mg azodicarbonamide per kg of flour;

1-50 mg, preferably 3-40 mg potassium bromate equivalents per kg of flour.

Here the term “ascorbic acid equivalents” refers to the amount of ascorbic acid that is employed or in case an ascorbic acid derivative is used, to the amount of ascorbic acid residue that is delivered by that derivative. The term “potassium bromate equivalents” refers to the amount of potassium bromate that is employed or in case another bromate salt is used, to the amount of potassium bromate that would deliver the equivalent amount of bromate. Most preferably, the oxidizing agent employed in the present method is ascorbic acid.

It is an essential aspect of the present method that during the high energy working employed to produce the underdeveloped dough, a vast number of small gas cells are incorporated into the underdeveloped dough. The inclusion of these small gas cells causes a limited density decrease of the dough. Typically, the underdeveloped dough obtained from the high energy working step has a density of less than 1.4 g/ml, most preferably of less than 1.3 g/ml.

The present method can suitably be used in the production of high quality bread using low protein wheat flour. Accordingly, in an advantageous embodiment of the present method, the dough-type mix contains less than 12% protein by weight of flour. Even more preferably, the dough-type mix contains less than 11%, most preferably less than 10% protein by weight of flour. The present method has also been shown to work with flour of protein contents of 13% and above.

The present invention may utilize various type of flours, such as wheat flour (including spelt flour), rye flour and oat flour. Typically, at least 70 wt. % of the flour contained in the dough-type mix is selected from wheat flour, rye flour, oat flour and combinations thereof. Wheat flour usually represents at least 10 wt. %, preferably at least 20 wt. % of the flour in the dough-type mix.

The low energy working employed in the present method to further develop the underdeveloped dough comprises subjecting the underdeveloped dough to deformation shear. Advantageously, the underdeveloped dough is worked by subjecting it to a deformation selected from compression, stretching and combinations thereof. Most preferably, the underdeveloped dough is worked by subjecting it to compression.

In the present method, the deformation of the underdeveloped dough advantageously comprises reducing the thickness of a layer of said underdeveloped dough by at least a factor 1.5. Even more preferably, the thickness of the layer of underdeveloped is reduced by at least a factor 2.0, more preferably by at least a factor 4.0 during deformation. Deformation (compression) of the layer of underdeveloped dough may suitably be achieved by passing the layer of dough underneath a roller or between a set of two or more rollers and by allowing these rollers to exert a pressure onto the dough layer (to squeeze the dough layer). Advantageously, the underdeveloped dough is subjected to a sequence of deformation actions, wherein the thickness of the sheet of dough that is obtained after each compression is increased again by at least a factor 2.0, preferably by at least a factor 4.0, by e.g. folding or rolling up the dough.

Examples of deformation techniques that may suitably be employed in the present method include lamination, as well as other techniques that employ devices containing individual or groups of compression rollers in any configuration, and combinations thereof. The inventors have found that particularly good results can be obtained with the present method in case the underdeveloped dough is worked by subjecting it to lamination. During lamination, the underdeveloped dough is subjected to both compression and shear, especially if it is laminated by passing the underdeveloped dough between top and bottom rollers rotating at different speeds.

The production of the underdeveloped dough by mixing and working the dough-type mix in a high energy mixer is typically completed within 5.0 minutes, preferably within 3.0 minutes and most preferably within 2.0 minutes. Usually at least 30 seconds of mixing are required to produce an underdeveloped dough that exhibits the right characteristics for further processing in accordance with the present method.

The further development of the underdeveloped dough in the second low energy working step typically requires not more than 10.0 minutes. Preferably, the second low energy working step requires not more than 6.0 minutes, most preferably not more than 2.0 minutes.

The present method enables the production of a leavened dough within 3 hours. In accordance with a particularly preferred embodiment, the present method yields leavened dough within 2.5 hours, or even within 2.0 hours.

Both traditional bread making processes and processes that employ mechanical dough development usually employ dough relaxation (or dough resting). The inventors have unexpectedly found that the present method can be used in the production of high quality bread without employing any relaxation steps. Accordingly, in accordance with a particularly preferred embodiment, prior to the leavening of the developed dough, neither the underdeveloped dough nor the developed dough is subjected to relaxation. Here the term “relaxation” refers to the resting of the dough of the dough under ambient conditions for a period of more than 2 minutes, especially for more than 1 minute.

The inventors have further discovered that the present method can suitably be used in the production of tin bread, but without employing any moulding of the developed dough. Thus, in another preferred embodiment of the invention the method does not comprise moulding of the developed dough.

As explained herein before, the present invention offers the advantage that the energy input needed to fully develop the dough within a short period can be reduced substantially. The amount of energy employed during the first high energy working step typically is lower than the energy typically employed in mechanical dough development. Thus, typically the total energy input from the mixer into the underdeveloped dough during the mixing and working of the dough-type mix is less than 11 W.h/kg (39.6 kJ/kg). Preferably the total energy input from the mixer into the underdeveloped dough during the high energy working step is less than 10 W.h/kg, more preferably less than 9 W.h/kg, even more preferably less than 8 W.h/kg and most preferably less than 7 W.h/kg.

It is important that during the high energy working step sufficient energy is transferred into the dough to bring about initial dough development. Advantageously, the energy input from the mixer into underdeveloped dough during the high energy working step exceeds 1.0 W.h/kg most preferably this energy input exceeds 2.0 W.h/kg.

In order to achieve sufficient dough development during the first high energy working step it is advisable to employ very vigorous mixing conditions. Accordingly, in a preferred embodiment, the total power input from the mixer into the dough-type mix exceeds 100 W/kg. Even more preferably said total power input exceeds 110 W/kg most preferably it exceeds 120 W/kg.

During the further, low energy working of the underdeveloped dough the energy that is transferred into the dough by this working operation is usually much lower than the energy transferred into the dough during the preceding high energy working step. Typically, during the low energy working step the energy input into the dough is less than 2 W.h/kg, more preferably less than 1 W.h/kg and most preferably less than 0.5 W.h/kg.

In the present method, the total energy input employed during the working of the dough can be much lower than the total energy input traditionally employed to mechanically develop dough. The inventors have found that the active cooling that is normally employed in mechanical dough development can be avoided in the present method due to the lower than usual requirement of energy input as a result of the invention. Hence, in an advantageous embodiment of the present invention during the mixing of the dough-type mix, said mix is not subjected to active cooling.

In accordance with a particularly advantageous embodiment of the present method, the developed dough is cut into two or more rectangular cuboids and these dough pieces are placed together in a tin to be leavened within said tin. Typically at least three dough pieces are placed in the same tin to be leavened therein. As will be explained in more detail below, bread having unique desirable properties can be produced if the dough pieces are cut from a developed dough layer and if these pieces are turned 90° before being placed into the tin.

The present method can suitably be used to produce yeast leavened as well as chemically leavened doughs. Preferably, the method is employed to produce a yeast leavened dough. In case the method employs yeast, leavening of the developed dough advantageously occurs at a temperature in excess of 30° C., more preferably in excess of 40° C. Furthermore, it is preferred to carry out said leavening at a relatively high relative humidity, e.g. humidity in excess of 60%. The leavening of the developed dough typically causes the dough to expand to a specific volume of at least 2.3 ml/g, most preferably of at least 3.0 ml/g.

The present method can suitably be used to produce a variety of leavened bread doughs, including white bread dough, whole meal bread dough and whole grain bread dough. The present method is particularly suited for use in the production of tin bread. Most preferably, the present method is used for the manufacture of sandwich bread, i.e. sliced tin bread that is used in industrial production of sandwiches.

The benefits of the present method are particularly apparent when the method is employed in large scale production of leavened dough. Accordingly, in a preferred embodiment of the present method a batch of at least 15 kg of underdeveloped dough is worked by subjecting it to deformation shear.

The present method can suitably be used in the preparation of bakery products that range from e.g. bread rolls to tin bread. Thus, in the present method typically the developed dough is divided into 2 or more dough pieces having an individual mass of 30-3000 g, preferably of 30-1500 g.

As explained herein before, the present method can suitably be used in the production of loaves of tin bread that have advantageous properties due to a unique cellular structure. The present method typically yields a layer of developed dough in which most gas cells are disk-shaped (oblate) ellipsoids whose equatorial radius lies within the dough layer. Advantageously, the dough layer is cut into a plurality of rectangular cuboids that are placed in a tin in such a way that the polar axis of the ellipsoids coincides with the length dimension of the tin. During the subsequent leavening operation, the oblate ellipsoids elongate in a vertical direction to form scalene ellipsoids. The special cellular structure so obtained is fixated during baking and imparts desirable properties to the bread so obtained.

Accordingly, another aspect of the invention relates to a loaf of tin bread having a specific volume of at least 3.5 ml/g and having a length “L” of 15-45 cm, a height “H” of 8-22 cm and a width “B” of 8-22 cm, wherein most of the cells contained in the loaf have the shape of scalene ellipsoids having a major equatorial radius “a”, a minor equatorial radius “b” and polar radius “c” with a>b>c; the polar radius coinciding with the length dimension of the loaf, the minor equatorial radius coinciding with the width dimension of the loaf and the major equatorial radius coinciding with the height dimension of the loaf.

Whenever reference is made in here to a particular radius of cells coinciding with a particular dimension of the loaf of bread what is meant is that the direction of said radius deviates by not more than 15°, preferably not more than 10° from the direction of the mentioned dimension. The main dimensions of the loaf of bread, i.e. the length dimension, the height dimension and the width dimension are perpendicular to one another and together form Cartesian coordinates having their point of origin in the centre of gravity of the loaf of bread.

If the aforementioned loaf is sliced perpendicular to its length, the surface of the individual slices shows a regular cellular structure. The open cells on the surface of the bread slices are relatively shallow. Thus, if these slices are spread with an edible coating such as butter or margarine, less coating material is needed to produce a continuous coating layer. In addition, the inventors have found that these same slices exhibit an exceptionally good resistance to tear if a coating is spread onto the slices, especially if the direction of the spreading coincides with the minor equatorial radius of the gas cells. Finally, the loaves of the present invention are characterized by a very regular shape, especially if they are produced as lidded tin bread. Thus, the present loaves can, for instance, be produced in a flawless rectangular shape that enables the preparation of e.g. triangular sandwiches in which the bread slices match perfectly.

The aforementioned advantages are particularly relevant when the present loaves are employed in the industrial production of sandwiches. Consequently, a further aspect of the invention relates to a process of industrial sandwich manufacture wherein slices from a loaf as described herein before are spread with a plastic edible coating such as margarine or butter.

The unique cellular structure of the present bread loaves becomes immediately apparent by comparing the cellular structures of the three different cross-sections that are obtained by cutting the bread through its centre in the directions perpendicular to the three main dimensions of the loaf. The cross-sections obtained by cutting slices from the loaf in the normal way show the same cellular structure as ordinary slices, i.e. a regular structure of shallow cells that are typically somewhat elongated in the direction coinciding with the height dimension of the loaf.

The cross-section obtained by cutting the loaf in a direction that is perpendicular to the height of the loaf shows a regular structure of cells that are relatively deep, i.e. substantially deeper than the cells found on the surface of the slices described above

The cross-section obtained by cutting the loaf in a direction that is perpendicular to the width of loaf shows a regular structure of strongly elongated cells. These cells are strongly elongated in the direction coinciding with the height dimension of the loaf

The special cellular structure of the present loaf of tin bread can be defined in quantitative terms with the help of a C-Cell™ instrument. C-Cell™ is an instrument for the evaluation of bread that uses dedicated image analysis software to quantify cell characteristics and external features (Supplier: Calibre Control International Ltd., Warrington, UK).

The unique cellular structure of the present loaf of tin bread can be demonstrated using the C-Cell™ instrument to analyse slices cut longitudinally through the centre of replicate loaves in two orthogonal planes, i.e. a longitudinal/vertical (xy) plane and a horizontal (xz) plane, where x is an axis parallel to the length of the loaf, y is vertical and z is across the width of the loaf. By suitably orienting the slices in the instrument, the “Vertical elongation” parameter measured by the instrument can be used to quantify the average elongation of the cells, V_{y} or V_{z} measured perpendicular to the length of the loaf, x, for the xy and xz planes respectively. The procedure for measuring the aforementioned parameters is described in detail in the Examples.

The loaves of the present invention are unique in that, due to special shape of the cells contained therein, these loaves meet the following requirement:

V_{y}>0.4; and

0.0<V_{z}<0.4;

Typically, the loaves according to the present invention have a V_{y} of greater than 0.45, more preferably of greater than 0.48 and most preferably of greater than 0.5.

V_{z} typically lies within the range of 0.00 to 0.35, more preferably in the range of 0.00 to 0.32 and most preferably of 0.02 to 0.30.

In accordance with another preferred embodiment, the loaves meet the following requirement: V_{y}+V_{z}>0.5. Even more preferably, the loaves meet the requirement: V_{y}+V_{z}>0.55. Most preferably, the loaves meet the requirement: V_{y}+V_{z}>0.58.

Yet another aspect of the present invention relates to an apparatus that can suitably be used to perform the method as described herein before. More specifically, the invention also provides an apparatus for producing a leavened bread dough, said apparatus comprising the following equipment:

a high speed dough mixer for mixing dough ingredients and working the resulting dough with a power input of at least 100 W/kg;

a first conveying means for transporting dough away from the high speed mixer;

a dough working means for low energy working of dough by means of deformation shear, said dough working means being positioned downstream of the first conveying means and comprising one or more rollers for squeezing a dough layer;

a second conveying means for transporting dough away from the dough working means;

a cutting device for dividing dough into two or more dough pieces, said cutting device being positioned downstream of the second conveying means;

a third conveying means for transporting dough away from the cutting device;

a proofing device for raising dough, said proofing device comprising means for controlling the temperature and humidity within the device and being positioned downstream of the third conveying means.

The present apparatus can employ any conveying means that is suitable for transporting dough and dough pieces. Advantageously, the first conveying means, the second conveying means and the third conveying means of the present apparatus comprise a conveyor belt.

Examples of high-speed dough mixers that may be employed in the present apparatus include: Tweedy mixers, Turkington mixers, Spiral mixers (e.g. Twin screw spiral mixers), pin mixers typically used for dough making in the USA, or horizontal bar mixers etc. Preferably, the high speed dough mixer that may suitably be employed in the present apparatus is a Tweedy mixer.

The dough working means for low energy working of the dough is suitably selected from the group consisting of laminating devices, devices containing individual or groups of compression rollers in any configuration, and combinations thereof. Most preferably, said dough working means comprises a laminating device.

The proofing device employed in the present apparatus preferably is a proofing cabinet, in either batch or continuous mode. Proofing of dough pieces with the proofing cabinet may, for instance, be achieved by moving the dough pieces at a constant speed through the proofing cabinet.

As explained herein before the present invention enables the preparation of leavened dough pieces without the need of moulding these dough pieces. Accordingly, in accordance with a preferred embodiment the apparatus does not comprise a moulding device.

The present apparatus is particularly suited for the production of tin bread. Thus, the present apparatus advantageously comprises a tin filling device that is positioned downstream of the third conveying means and upstream of the proofing device, said tin filling device comprising a first inlet for empty tins, a second inlet for dough pieces that is positioned downstream of the third conveying means, a means for transferring one or more dough pieces from the second inlet into empty tins from the first inlet, and an outlet for tins that have been filled with one or more dough pieces.

The invention is further illustrated by means of the following non-limiting examples.

### EXAMPLES

### Procedure for Determining Average Cell Elongation Using C-Cell™ Instrument

C-Cell™ is a system which uses digital image analysis to measure the dimensions and crumb structure of slices of leavened baked products such as bread. The system was developed by Campden BRI in collaboration with Calibre Control International Ltd., from whom it is available commercially. Further information is available at www.c-cell.info. The system comprises a cabinet for presentation of samples, and software to capture and analyse images.

Slices of bread are cut using a rotary slicer (Graef model FA-182). This provides a good quality cut surface, enabling the product structure to be clearly revealed. Slices are placed on a tray in a drawer at the base of the cabinet.

The slices are illuminated obliquely from the left and right of the tray. The oblique illumination casts shadows into the cells in the structure, providing good contrast between these and the more brightly illuminated cell walls. A monochrome image of the slice is taken with a CCD camera, at a magnification of 0.14 mm/pixel. The brightness scale of the images is calibrated using a reference grey card. Images of slices are analysed with C-Cell software Version 2 to measure the slice dimensions and cell structure. The analysis includes identification of individual cells within the structure, and measurement of their size, brightness (which is indicative of depth), elongation and orientation.

To provide flexibility in presenting slices of varying dimensions on the rectangular C-Cell tray, the option is provided to present slices in a sideways or upright orientation, with the top of the slice towards the right or the back of the drawer respectively. The software can be configured accordingly. Because the illumination is directional, from the left and right of the tray, the appearance of the structure is affected by the orientation in which slices are presented. Slices should therefore be presented in a consistent orientation for comparison of measurements. In the experiments described in the following Examples, transversely cut slices were presented in the sideways orientation, with the top of the slice towards the right of the tray. Longitudinally cut slices were too large to fit in the tray and were therefore cut into two halves for analysis, each of which was presented with the direction corresponding to the longitudinal axis of the loaf, x, parallel to the width of the C-Cell tray.

The standard C-Cell™ parameter “Vertical Elongation” measures the average elongation of the cell structure within a slice, parallel to a certain axis (the “measurement direction”). High positive values indicate strong elongation of cells in the measurement direction. High negative values indicate strong elongation of cells perpendicular to the measurement direction. Intermediate values indicate lesser cell elongation or alignment, or a structure aligned in a direction that is intermediate between the measurement direction and a direction perpendicular to the measurement direction.

In the experiments described in the following Examples, the C-Cell software was configured to analyse longitudinally cut slices in an “upright” orientation. In this configuration, the measurement direction is perpendicular to the edge of the slice lying closest to the front of the instrument tray. i.e. for the slices presented as described, the elongation of vertical, longitudinal slices (xy plane) was measured parallel to the height of the loaf, y; this was denoted V_{y}. The elongation of horizontally cut slices (xz plane) was measured parallel to the width of the loaf, z; this was denoted V_{z}.

### Example 1

White tin bread was produced on the basis of the following dough recipe:

| | % (Bakers' | |
|---|---|---|
| Ingredient | percentage) | Grams |
| Flour | 100 | 15000 |
| Yeast | 2.5 | 375 |
| Salt | 2 | 300 |
| Fat | 1 | 150 |
| Ascorbic Acid | 0.01 | 1.5 |
| Emulsifier | 0.33 | 49.5 |
| Fungal α- | 0.001636* | 0.2454 |
| amylase | | |
| Water | 57.6** | 8640 |

*Calculated from flour analysis to achieve 80 Farrand Units
**Determined using a Brabender Farinograph (600 Line)

The ingredients specifications are provided in the following table:

| Flour | U.K. commercially available wheat flour with statutory | |
|---|---|---|
| | nutrients as per “Bread and Flour Regulations 1998” | |
| | Flour analysis: | |
| | Protein (%) as is (Dumas) | 10.7 |
| | Moisture (%) | 14.1 |
| | Damaged Starch (Farrand) | 32 |
| | Grade Colour (Kent-Jones) | −1.8 |
| | Ash (%) as is | 0.68 |
| | Brabender Farinograph (600 Line) | |
| | Water absorption (%) as is | 57.6 |
| | Development time (min) | 2.0 |
| | Stability (min) | 3.5 |
| | Degree of softening (BU) | 90 |
| Yeast | Ex DCL ™; High Activity compressed yeast, craft-bake | |
| | (blue label). | |
| Salt | Standard pure dried vacuum salt. | |
| Fat | Ex BAKO ™; bread fat. A white translucent fat/emulsion. | |
| | Composition: | |
| | Vegetable oils and | 45% |
| | hydrogenated vegetable oils: | |
| | Water | 50.4% |
| | Salt | 2.36% |
| | E471 | <1% |
| | E330 | <1% |

| | |
|---|---|
| Ascorbic | Ex VWR International ™; Ascorbic Acid, L(+). |
| Acid | |
| Emulsifier | Ex Danisco ™; Panodan A3010 |
| Fungal α- | Ex Novozymes ™; Fungamyl SG 1600 |
| amylase | |
| Water | Mains tap water |

A leavened dough was prepared as follows:

1) All the ingredients were placed into a Tweedy 70 mixer (Baker Perkins Ltd., Peterborough, UK) with blade speed set at 307 rpm. Work Input at 3 W.h/kg. Mixer headspace at atmospheric conditions.

2) The dough piece was processed by a dough brake (Panattrezzi RA 600, Panattrezzi snc, San Vittore di Cesena (FC), Italy) as follows:

2 passes at 15.9 mm gap and triple fold and 90° turn between each pass.

20 passes at 15.9 mm gap with double fold and 90° turn between each pass.

2 passes at 20.2 mm gap with double fold and 90° turn between each pass.

1 pass at 22.4 mm gap.

3) The sheet of dough coming from the dough brake was placed on a table then cut in strips of 95 mm width and 235 mm long.

4) The dough pieces obtained at step 3) were weighed and if necessary adjusted to give 930 g.

5) The 930 g dough piece was divided by hand in 4 equal pieces.

6) The 4 dough pieces obtained at step 5) were turned by 90° with respect to their vertical axis.

7) The 4 dough pieces from step 6) were placed into a bread tin. Pan size (top): 250×122 mm; 125 mm deep.

8) The tin was placed into a proofer set at 43° C. and 70% relative humidity. The proving step was terminated when dough reached the height of 11 cm.

9) The leavened dough was placed into a direct gas-fired reel oven at 240° C. for 30 minutes.

10) The baked bread was left to cool at ambient.

### Comparative Example A

White tin bread was produced using the same recipe as described in Example 1, but this time using a method based on the traditional Chorleywood Bread Process.

The processing conditions employed in the CBP were as follows:

1) All the ingredients were placed into a Tweedy 70 mixer with blade speed set at 307 rpm. Work Input at 11 W.h/kg. Mixer headspace at positive and vacuum (2.0 bar/0.34 bar) condition, changeover at 50% of total work input.

2) The dough piece was scaled by hand to 930 g.

3) The 930 g dough piece was moulded to a ball using a conical moulder.

4) The 930 g dough ball was rested for 7 minutes at ambient temperature.

5) The final moulding was obtained using a Sorensen Moulder, set as follows:

Rollers: 9

Side Guide Bars: 9.5

Pressure Board: 1.25

At the exit from the pressure board the cylinder shaped dough piece was cut into 4 pieces by a static blade.

1) The 4 dough pieces obtained at step 5) were turned by 90° with respect to their horizontal axis.

2) The 4 dough pieces from step 6) were placed into a bread tin. Pan size (top): 250×122 mm; 125 mm deep.

3) The tin was placed into a proofer set at 43° C. and 70% relative humidity. The proving step was terminated when dough reached the height of 11 cm.

4) The leavened dough was placed into a direct gas-fired reel oven at 240° C. for 30 minutes.

5) The baked bread was left to cool at ambient.

### Example 2

The process described in Example 1 was compared to the CBP described in Comparative Example A in terms of energy consumption and also by looking at the physical properties of the dough and tin bread produced in each process. The results of this comparison are shown below.

| | | Comparative |
|---|---|---|
| | Example 1 | Example A |
| Dough measurements | | |
| Dough density (g/ml) | 1.09 ± 0.01 | 1.17 ± 0.01 |
| Gel protein elastic modulus (G′) | 3.70 ± 0.14 | 0.83 ± 0.16 |
| Gel protein viscous modulus (G″) | 1.78 ± 0.04 | 0.79 ± 0.12 |
| Gliadin:glutenin ratio (by SE- | 4.20 ± 0.14 | 4.67 ± 0.04 |
| HPLC) | | |
| Bread measurements | | |
| C-Cell ™ Number of cells | 12680 ± 465 | 11402 ± 310 |
| C-Cell ™ Cell volume | 3.30 ± 0.12 | 4.02 ± 0.09 |
| C-Cell ™ Cell contrast | 0.8232 ± 0.008 | 0.7895 ± 0.005 |
| Firmness (g) | 116 ± 18 | 153 ± 24 |
| Specific volume (ml/g) | 4.36 ± 0.08 | 4.21 ± 0.07 |

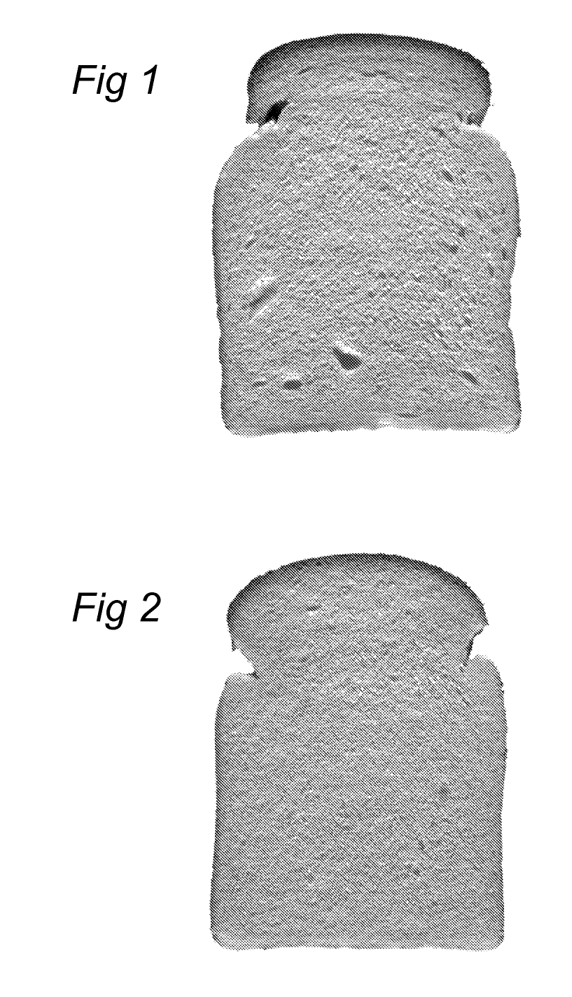

The baked breads obtained by the processes described in Example 1 and Comparative Example A were sliced after cooling. A C-Cell™ Image was obtained for a representative slice from bread made in each example. These Images are depicted in FIG. 1 (slice of CBP bread) and FIG. 2 (slice of bread obtained by the present process).

The above mentioned data as well as the brightness images clearly show that the method according to the present invention can be used to produce high quality bread within a short time frame whilst employing a much lower energy input than the traditional Chorleywood Bread Process. Furthermore, these data show that the non-leavened developed dough, produced by the process of the present invention, is both stronger (G′ and G″) and lighter (density) than the CBP dough, and that it shows more gluten development than the CBP dough. This is due to the new method producing lower levels of extractable gluten proteins, as demonstrated by Size Exclusion High Pressure Liquid Chromatography (SE-HPLC) results. Finally, it is evident from the data and images that the baked bread obtained by the present process has a softer crumb than and comparable specific volume to the baked bread obtained by the CBP.

### Example 3

Example 1 was repeated except that the water content of the dough was slightly increased from 57.6 to 58.7% by weight of flour. In addition, the work input in the Tweedy mixer was increased to 5 W.h/kg and the processing of the dough piece by the dough brake was altered as follows:

15 passes at 15.9 mm gap with double fold and 90° turn between each pass.

5 minute rest period at ambient temperature.

2 passes at 20.2 mm gap with double fold and 90° turn between each pass.

1 pass at 22.4 mm gap.

Dough handling and bread quality were as for Example 1.

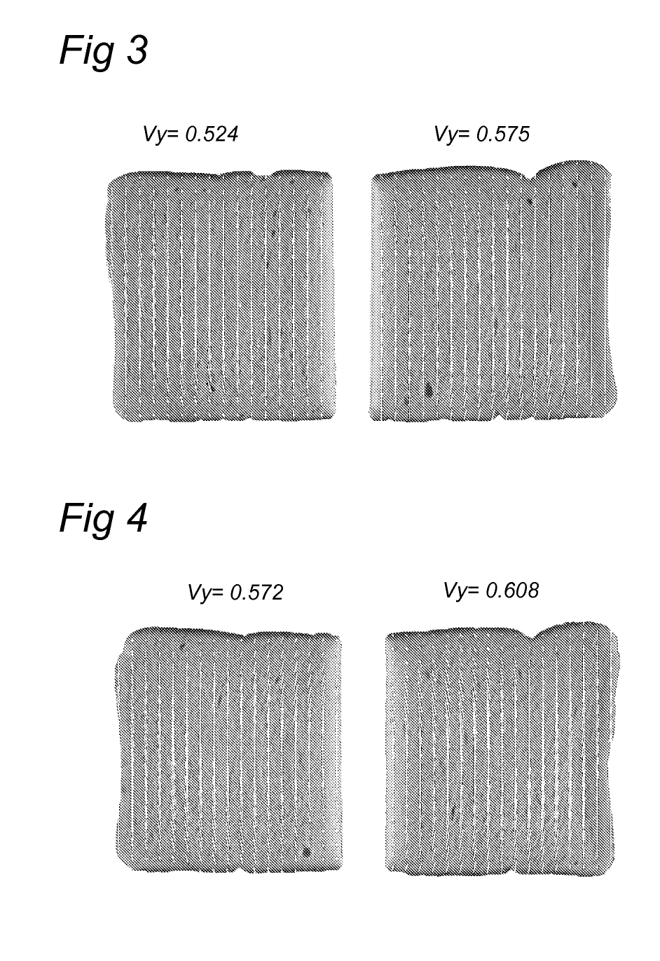

The baked breads so obtained were cut and analyzed in a C-Cell™ instrument using the procedure described herein before. A cross-section of the loaves was produced by cutting the loaves in half in a longitudinal/vertical direction (xy plane). In order to be able to fit the sample in the instrument, the cross-section was divided in two samples of equal size. Both samples were analysed separately. The elongation vectors were calculated and depicted as white lines in the images of these samples. The images so obtained are depicted in FIG. 3. The average elongation, V_{y}, measured parallel to the vertical axis, y, was found to be 0.524 in one sample and 0.575 in the other sample, meaning that the cells in the sample exhibited a very strong vertical elongation. As is evident from FIG. 3, the vertical orientation of the cells in the samples was also very homogeneous.

Further cross-sections were produced by cutting the loaves in half in a horizontal direction (xz plane). Again the two samples were produced by dividing the cross-section in two samples of equal size. The average elongation, V_{z}, measured parallel to the width of the loaf, z, for the two samples was 0.169 and 0.177 respectively.

### Example 4

Example 1 was repeated except that this time the dough was developed fully in the Tweedy mixer using 11 W.h/kg. The dough was given a 5 minute rest period at ambient temperature before laminating using 2 passes at 20.2 mm gap with double fold and 90° turn between each pass and a final pass at 22.4 mm gap. Dough handling and bread quality were as for Example 1.

The baked breads so obtained were cut and analysed in the same way as in Example 3. The C-Cell™ images obtained for the longitudinal/vertical (xy) cross-section are depicted in FIG. 4. The average elongation, V_{y}, measured parallel to the vertical axis, y, was found to be 0.572 in one sample and 0.608 in the other sample, meaning that the cells in the sample exhibited a very strong vertical elongation. As is evident from FIG. 4, the vertical orientation of the cells in the samples was also very homogeneous.

The average elongation values, V_{z}, measured parallel to the width of the loaf, z, for the two samples were 0.145 and 0.145.

### Comparative Example B

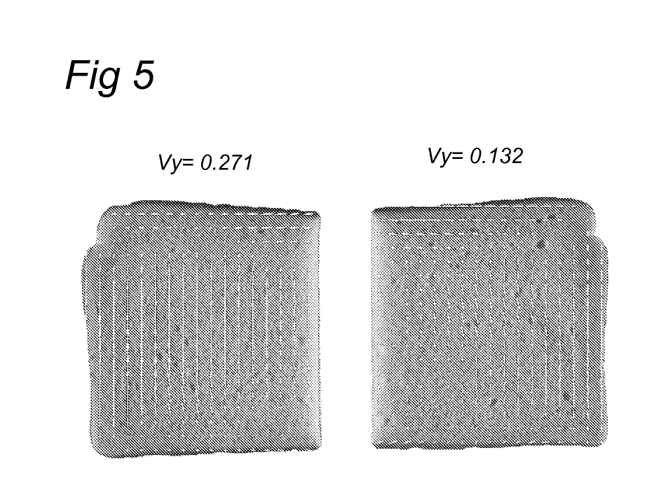

Comparative Example A was repeated, except that after moulding with the Sorenson, the sheeted and rolled dough was put into the tin in one piece. The baked breads so obtained were cut and analyzed in the same way as in Example 3. The C-Cell™ images obtained for the longitudinal/vertical (xy) cross-section are depicted in FIG. 5. The average elongation, V_{y} measured parallel to the vertical axis, y, was found to be 0.271 in one sample and 0.132 in the other sample, meaning that the cells in the sample exhibited a limited degree of average vertical elongation. As is evident from FIG. 5, the orientation of the cells in the samples was far from homogeneous.

The average elongation, V_{z}, measured parallel to the width of the loaf, z, for the two samples was 0.037 and 0.054 respectively.

### Example 5

Example 1 was repeated except that this time wholemeal tin bread was produced by replacing white flour with wholemeal flour of the following specification.

Flour analysis:

| | |
|---|---|
| Protein (%) as is (Dumas) | 12.2 |
| Falling number (s) | 357 |
| Brabender Farinograph (600 Line) | |
| Water absorption (%) as is | 63.1 |
| Development time (min) | 8.5 |
| Stability (min) | 5.0 |
| Degree of softening (BU) | 60 |

The dough recipe was the same as for Example 1 except for the following:

| | % (Bakers' | |
|---|---|---|
| Ingredient | percentage) | Grams |
| Fat | 2 | 300 |
| Fungal α- | n/a | 0.1532* |
| amylase | | |
| Water | 63.1** | 9465 |

*Calculated from flour analysis to achieve 80 Farrand Units
**Determined using a Brabender Farinograph (600 Line)

A leavened dough was prepared in the same way as for Example 1 except that the Tweedy 70 mixer work input was 7 W.h/kg and the dough brake lamination schedule was.

15 passes at 15.9 mm gap with double fold and 90° turn between each pass.

1 pass at 18.0 mm gap with double fold and 90° turn.

5 minute rest period at ambient temperature.

2 passes at 20.2 mm gap with double fold and 90° turn between each pass.

1 pass at 23.5 mm gap.

All other dough handling and baking were as for Example 1.

### Example 6

Example 1 was repeated except that this time whole grain tin bread was produced by replacing white flour with whole grain flour of the following specification.

Flour analysis:

| | |
|---|---|
| Protein (%) as is (Dumas) (sieved) | 13.1 |
| (Buhler ground) | 12.8 |
| Falling number (s) | 174 |
| Brabender Farinograph (600 Line) | |
| Water absorption (%) as is | 65.1 |
| (reduced to 56.0% for recipe) | |
| Development time (min) | 5.0 |
| Stability (min) | 7.0 |
| Degree of softening (BU) | 120 |

The dough recipe was the same as for Example 1 except for the following:

| | % (Bakers' | |
|---|---|---|
| Ingredient | percentage) | Grams |
| Fat | 2 | 300 |
| Fungal α- | n/a | 0.1135* |
| amylase | | |
| Water | 56.0** | 8400 |

*Calculated from flour analysis to achieve 80 Farrand Units
**Determined using a Brabender Farinograph (600 Line)

A leavened dough was prepared in the same way as for Example 1 except that the Tweedy 70 mixer work input was 7 W.h/kg and the dough brake lamination schedule was.

15 passes at 15.9 mm gap with double fold and 90° turn between each pass.

5 minute rest period at ambient temperature.

2 passes at 20.2 mm gap with double fold and 90° turn between each pass.

1 pass at 23.5 mm gap.

All other dough handling and baking were as for Example 1.

### Example 7

Example 1 was repeated except that this time the salt level in the recipe was reduced from 2.0 to 1.0%. Dough handling and bread quality were as for Example 1.

### Example 8

Example 1 was repeated except that this time the ascorbic acid level in the recipe was reduced from 100 to 50 mg per kg of flour. Dough handling and bread quality were as for Example 1.

1. A method of preparing a yeast or chemically leavened bread dough, said method comprising the following sequence of processing steps:
combining flour, water, yeast and/or leavening agent, and optionally one or more additional bakery ingredients to produce a dough-type mix;
mixing and working the dough-type mix in a mixer to produce an underdeveloped dough with a density of 0.9-1.5 g/ml, the total energy input from the mixer into the underdeveloped dough during said mixing and working of the dough-type mix being at least 1 W.h/kg (3.6 kJ/kg);
further working a batch of at least 15 kg of the underdeveloped dough by subjecting it to deformation shear, thereby producing a developed dough;
dividing the developed dough into two or developed dough pieces having an individual mass of 30-3000 g; and
leavening the developed dough pieces to yield leavened dough pieces having a specific volume of at least 2.0 ml/g;
wherein the aforementioned sequence of processing steps is completed within 3 hours.

2. The method according to claim 1, wherein the dough-type mix contains one or more oxidizing agents selected from:
10-300 mg ascorbic acid equivalents per kg of flour;
5-100 mg azodicarbonamide per kg of flour;
1-50 mg potassium bromate equivalents per kg of flour.

3. The method according to claim 1, wherein, prior to the leavening of the developed dough, neither the underdeveloped dough nor the developed dough is subjected to relaxation.

4. The method according to claim 1, wherein the method does not comprise moulding of the developed dough.

5. The method according to claim 1, wherein the underdeveloped dough is subjected to a deformation selected from compression, stretching and combinations thereof.

6. The method according to claim 1, wherein the underdeveloped dough is worked by subjecting it to lamination.

7. The method according to claim 1, wherein the total energy input from the mixer into the underdeveloped dough during the mixing and working of the dough-type mix is less than 11 W.h/kg (39.6 kJ/kg).

8. The method according to claim 1, wherein the leavened bread dough is a leavened tin bread dough.

9. The method according to claim 1, wherein the compression of the underdeveloped dough comprises reducing the thickness of a layer of said underdeveloped dough by at least a factor 1.5.

10. The method according to claim 1, wherein during the mixing of the dough-type mix said mix is not subjected to active cooling.

11. The method according to claim 1, wherein a layer of the developed dough is cut into rectangular cuboids and wherein two or more dough pieces are placed together in a tin after having been turned 90°, followed by leavening the dough pieces within said tin.

12. A loaf of tin bread having a specific volume of at least 3.5 ml/g and having a length “L” of 15-45 cm, a height “H” of 8-22 cm and a width “B” of 8-22 cm, wherein most of the cells contained in the loaf have the shape of scalene ellipsoids having a major equatorial radius “a”, a minor equatorial radius “b” and polar radius “c” with a>b>c; the polar radius coinciding with the length dimension of the loaf, the minor equatorial radius coinciding with the width dimension of the loaf and the major equatorial radius coinciding with the height dimension of the loaf.

13. The loaf according to claim 12, wherein the loaf meets the following requirement:
V_{y}>0.4; and
0.0<V_{z}<0.4;
wherein V_{y} represents the average vertical elongation for a central slice in the vertical longitudinal plane and V_{z} represents the average elongation parallel to the width of the loaf for a central slice in the horizontal plane.

14. The loaf according to claim 12, wherein the tin bread is a lidded tin bread.

15. The loaf according to claim 12, wherein the loaf of tin bread is obtained by baking a leavened dough that is obtained by a method according to claim 1.

16. An industrial process of sandwich manufacture wherein slices from a loaf according to claim 12 are spread with a plastic edible coating.

17. An apparatus for producing a leavened bread dough, said apparatus comprising the following equipment:
a high speed dough mixer for mixing dough ingredients and working the resulting dough with a power input of at least 100 W/kg;
a first conveying means for transporting dough away from the high speed mixer;
a dough working means for low energy working of dough by means of deformation shear, said dough working means being positioned downstream of the first conveying means and comprising one or more rollers for squeezing a dough layer;
a second conveying means for transporting dough away from the dough working means;
a cutting device for dividing dough into two or more dough pieces, said cutting device being positioned downstream of the second conveying means;
a third conveying means for transporting dough away from the cutting device; and
a proofing device for raising dough, said proofing device comprising means for controlling the temperature and humidity within the device and being positioned downstream of the third conveying means.

18. The apparatus according to claim 17, wherein the high-speed mixer is a Tweedy mixer.

19. The apparatus according to claim 17, wherein the dough working means comprises a laminating device.

20. The apparatus according to claim 17, wherein the apparatus comprises a tin filling device that is positioned downstream of the third conveying means and upstream of the proofing device, said tin filling device comprising a first inlet for empty tins, a second inlet for dough pieces that is positioned downstream of the third conveying means, a means for transferring one or more dough pieces from the second inlet into empty tins from the first inlet, and an outlet for tins that have been filled with one or more dough pieces.
